(19) United States
(12) Patent Application Publication
(10) Pub. No.: US 2006/0172168 A1
(43) Pub. Date: Aug. 3, 2006

(54) Deposited structures

(76) Inventors: Emma V Wright, Farnborough (GB); Jonathan Gore, Farnborough (GB); Alan Hooper, Farnborough (GB); Laura D Walker, Farnborough (GB)

Correspondence Address: NIXON & VANDERHYE, PC, 901 NORTH GLEBE ROAD, 11TH FLOOR, ARLINGTON, VA, 22203, US

(21) Appl. No.: 10/541,301

(22) PCT Filed: Jan. 8, 2004
(86) PCT No.: PCT/GB04/00045

§ 371 Date: Jun. 30, 2005

(30) Foreign Application Priority Data
Jan. 10, 2003 (GB) 0300533.7
Jan. 10, 2003 (GB) 0300529.5

(51) Int. Cl. B05D 5/12; B05D 1/32

(52) U.S. Cl. 429/32; 427/115; 427/466

(57) ABSTRACT

A composition, method and apparatus for ink jet deposition of structures are described. Structures which may be deposited have many advantages as a result of their small scale. This is believed to be a result of the sub-micron sized loading used in the composition. Solid Oxide Fuel Cells (SPFCs) are a particular structure which may advantageously be deposited.

The present invention relates to a composition, method and apparatus for ink jet deposition of structures, particularly, although not exclusively, of sub-micron sized structures.

It has been recognised that the materials processing and production techniques conventionally used in the manufacture of electrical, optical and mechanical components places a limitation upon their performance. In part, the limitation is believed to be attributed to the particulate size of materials from which such components are formed. Consequently, there has been much theoretical and practical work aimed at overcoming the performance disadvantages inherent in traditional materials processing and production techniques. In particular, there has been a concentration on the development of so-called nano-sized materials, that is materials whose particulate sizes are below one micron (<1 μm).

Whilst some nano-sized materials have been prepared experimentally and are indeed available. commercially in restricted quantities, the availability of suitable processing and production techniques remains a barrier to the full scale adoption of the technology. As a result, the anticipated benefits in terms of the improved performance characteristics of components manufactured using such materials are not being realised. By way of example, one such known manufacturing approach is that of photolithography. However, photolithography requires the use of lengthy, labour intensive processes and expensive patterning masks. A mask must be created for each application and/or device. As a result photolithography seems not to meet a primary commercial requirement of low cost.

It is also the case that in parallel with developments in the field of nano-material manufacture, there have been advances in the processes applied to the manufacture of components at the micron and greater scales. U.S. Pat. No. 5,882,722 describes a thick film formed of a mixture of metal powders and metallo organic decomposition compounds in an organic liquid vehicle. The document also sets out a process for applying such a thick film to a substrate. However, the processes suggested in the document for applying such a film to a substrate such as screen printing, suffer from the disadvantages identified in general terms above. Another approach taken by those in the field has been that of ink jet printing in both so-called direct and indirect formats. Ink jet printing has applications as a deposition technique for materials consisting of particles greater than one micron in diameter (>1 μm). Although direct ink jet printing is under investigation by some researchers, the structures which can be produced are very limited in terms of the type of materials which can be deposited and the accuracy of the structures which can be produced. Direct printing uses an ink containing a solid loading of the material to be printed, much in the same way that a graphical ink contains the required pigment. Alternatively a derivative of the required material, such as a salt, oxide or complex, can be used in suspension and printed, for later conversion to the required material. In some cases, it appears that there have been attempts even to utilise nano-sized materials in the direct ink-jet printing process. For example, U.S. Pat. No. 6,361,161 suggests that images may be produced using nano-sized particles. Nevertheless, such techniques do not appear to have been commercially adopted, primarily it is believed, owing to the difficulty in formulating a suitable ink.

Turning to indirect printing there has been much work directed at a particular deposition technique which has found favour in the production of structures as opposed to image formation. The process, which has similarities to an investment casting, is used to produce wax moulds within which a component is subsequently formed in a separate process.

It is the case that there has been much recent interest in the development of processes for the creation of so-called nano-structures. A typical nano-structure has dimensions of the order of several microns and is made up of features an order of magnitude smaller. It is expected that such structures will exhibit exotic characteristics which are considered to be a function of the small size and particularly the large surface areas of such materials.

It is well known that many processes have been suggested as a means of creating such structures. For the most part these processes have been complex, time-consuming and seemingly unsuitable for large-scale production at reasonable cost. Indeed, there have been proposals which set out methods of developing and building devices by means of deposition via printing. U.S. Pat. No. 6,294,401 for example teaches a method of fabricating active components by printing inks containing nano-materials. EP0955685, on the other hand, teaches methods of screen printing electrodes on either surface of a solid electrolyte. Finally, US20020098401A1 describes fabrication of a structure using multi-layer deposition.

In the case of EP0955685 and US20020098401A1, there is disclosed a method of fabricating a particular class of structure known as a solid oxide fuel cell. A solid oxide fuel cell (SOFC) is a particular class of fuel cell in which the functional components are all solid state. As such, it may be contrasted with the alkali fuel cell known from the spaceflight programme of the United States of America. SOFCs are considered to be one of the most likely contenders for practical power generation in static applications and may also prove to have potential in mobile applications.

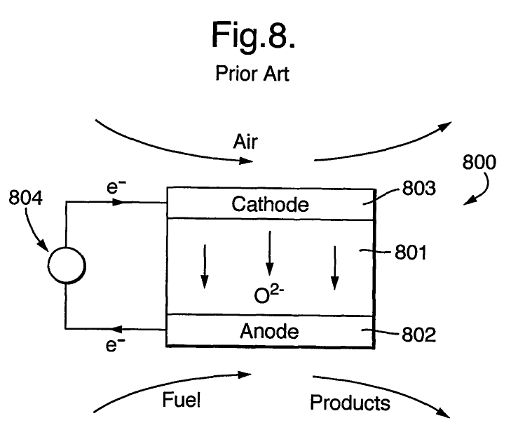

Typically, as shown in FIG. 8, a SOFC 800 includes a dense electrolyte 801 sandwiched between an anode 802 and a cathode 803. Both electrodes 802,803 are sufficiently porous to allow a chemical reaction to take place between, on the cathode side of the fuel cell, oxygen and on the anode side, a hydrocarbon fuel. The fuel on the anode side is oxidised by oxygen ions which travel across the electrolyte 801 from the cathode 803. Useful electrical energy is thereby generated and extracted from an external circuit 804 connecting the electrodes.

In a practical power unit, a number of such fuel cells will be combined in a stack which may be planar or of some other geometric configuration. Interconnects are required in such a stack to carry the current in much the same way that conventional electrochemical cells are connected to form a battery. In view of the high temperatures currently reached during the operation of SOFCs, it is ceramic material interconnects are utilised. An example of such a material is lanthanum chromite.

It has been further recognised that a particular limitation on the performance of a SOFC is the thickness of the electrolyte. In particular resistance or ohmic losses and thus a reduction in fuel cell efficiency, arise in direct proportion to the thickness of the electrolyte layer.

Thus, according to one aspect of the present invention, there is provided a solid structure fabrication method, the method comprising filling each of a plurality of reservoirs with a selected ink, the ink containing a solid material loading of nanosized particles, ejectng a selected ink from a print head connected to a corresponding reservoir towards a medium surface, the print head and medium surface being movable relative to each other in a plane defined by first and second directions and in a third direction orthogonal to said plane

Advantageously, there is no requirement for a precursor material. Accordingly, complexities are avoided which are inherent in any conversion process from a precursor material. Furthermore, because the particulate size is known at outset of the ink formulation process and significantly is amenable to analysis, more confidence can be had in the specifications of structures fabricated in accordance with the invention. Preferably, a number of print heads will be available each connected to a corresponding reservoir containing an ink used in the fabrication of the structure. Where there is a need for voids, depressions or such like in the structure, then a reservoir may be filled with a fugitive material. Typically, the fugitive material is removed in a subsequent step such as sintering, firing or the like. A sintering step will, of course, be required when a ceramic material is deposited. Whilst such a sintering step could take place after the deposition of each ceramic layer, it is preferable to carry out sintering once substantially all the layers, including those layers containing ceramic materials, have been deposited.

Preferably, the method permits the selective deposition of material in a layer such that a set of graded layers may be deposited. A structure graded in this manner can confer benefits in terms of reducing any mismatch between thermal expansion rates of different loadings in the separate layers. This is particularly advantageous during a sintering process and indeed subsequently in applications of the structure, such as SOFCs where elevated temperatures are reached during service.

It will be recognised that unlike indirect deposition techniques, the present invention facilitates the introduction of interconnects during the fabrication process. This capability is advantageous in that it may remove some difficulties traditionally present in post fabrication processes such as sintering and the like.

In accordance with a further aspect of the invention, there is provided a method of fabricating a solid oxide fuel cell, the method comprising filling each of a plurality of reservoirs with a selected ink corresponding to an anode, electrolyte and cathode material, each ink containing a solid material loading of nanosized particles, wherein the solid oxide fuel cell is generated as a plurality of layers, each layer being laid down by ejecting at least one selected ink towards a medium surface such that an electrolyte layer separates a cathode and anode layer to form a cell.

It is advantageous if the anode can be built up into a layer having sufficient structural integrity to support the electrolyte and cathode layers. The electrolyte layer itself may be deposited as a very thin layer having a thickness of around 100 or less microns so as to minimise ohmic losses in the completed fuel cell. Furthermore, unlike indirect deposition techniques there is no restriction on the introduction of interconnects during build process. In addition, as a consequence of the reduction in ohmic losses due to the thinner electrolyte layer, the SOFC may operate at a lower temperature. Consequently, it may be convenient to utilise metallic interconnects. It will be recognised that one advantage is that a seal may be more easily formed around a metallic interconnect. Another advantage of a metallic interconnect is the relative ease, in comparison to a ceramic material, with which a connection may be formed to circuitry external of the SOFC.

According to another aspect of the invention, there is provided an ink-jet deposition apparatus intended for use with above described methods to deposit a structure on a medium surface, the apparatus comprising a plurality of print heads connectable to a selected ink reservoir, the print heads and medium surface being movable relative to each other in a plane defined by first and second directions and in a third direction orthogonal to said plane.

Preferably, the medium surface is supported on a bed. The bed may be fixed, in which case the print heads are translatable in the third direction. Alternatively, the bed may be raised and lowered with respect to the print heads providing the relative movement in the third direction.

In accordance with a yet further aspect of the invention there is provided a structure deposited in accordance with one of the above described methods.

Such structures might include Solid Oxide Fuel Cells (SOFCs), Micro Electro Mechanical Systems (MEMS) and indeed other utilising nanometric material capable of being formulated as an ink composition for deposition in accordance with the forgoing aspects of the invention. Such structures would provide, advantages in terms of the thin deposition layers achievable. In the particular case of a SOFC this would facilitate the creation of solid electrolyte layers having low ohmic losses.

In order to assist in understanding the invention, an embodiment thereof will now be described, by way of example, and with reference to the accompanying drawings, in which:

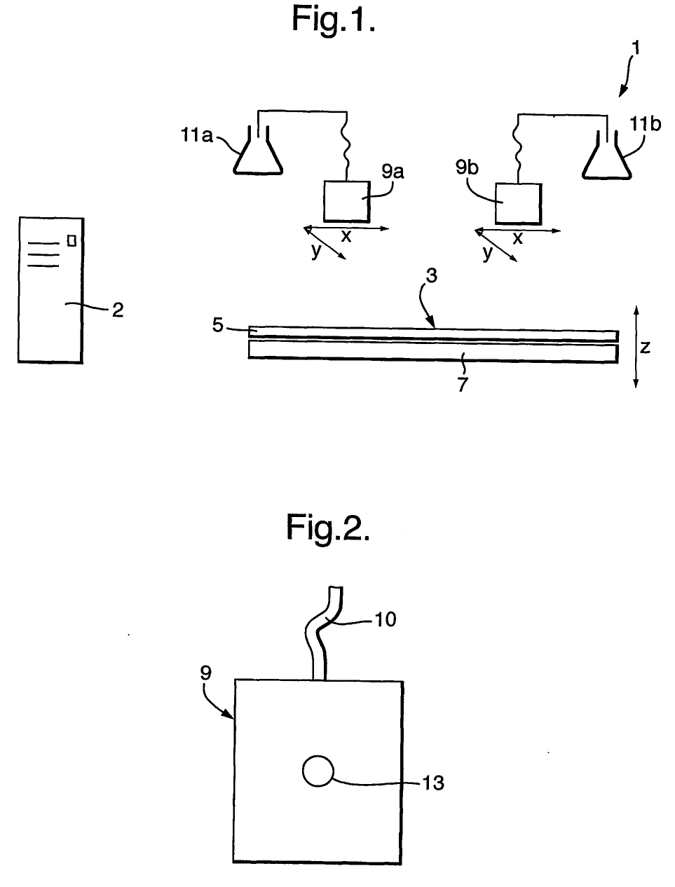

FIG. 1 is a schematic diagram showing an ink jet printer for use in accordance with an aspect of the present invention;

FIG. 2 is a schematic diagram showing a print head for use with the printer of FIG. 1;

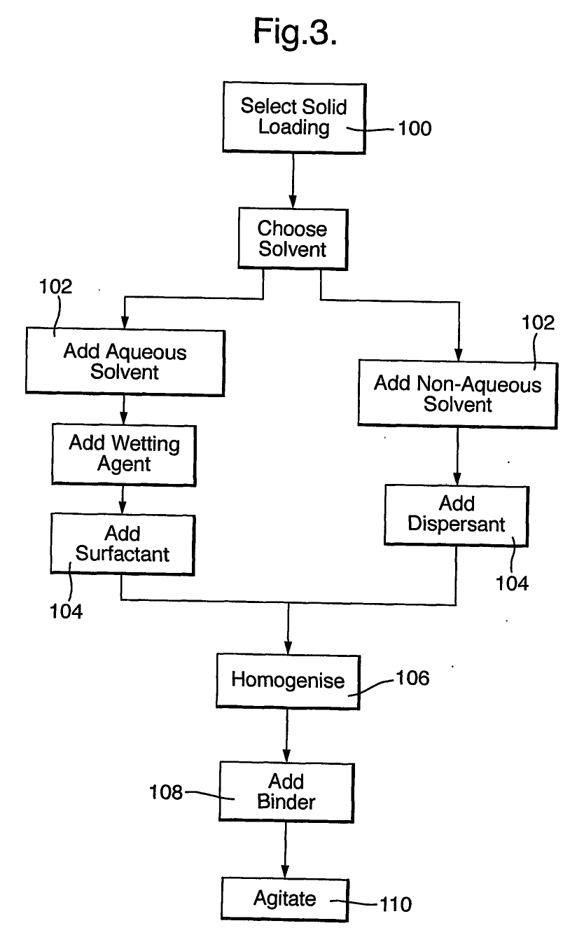

FIG. 3 is a flow chart illustrative of a method of ink formulation for use in accordance with an aspect of the invention;

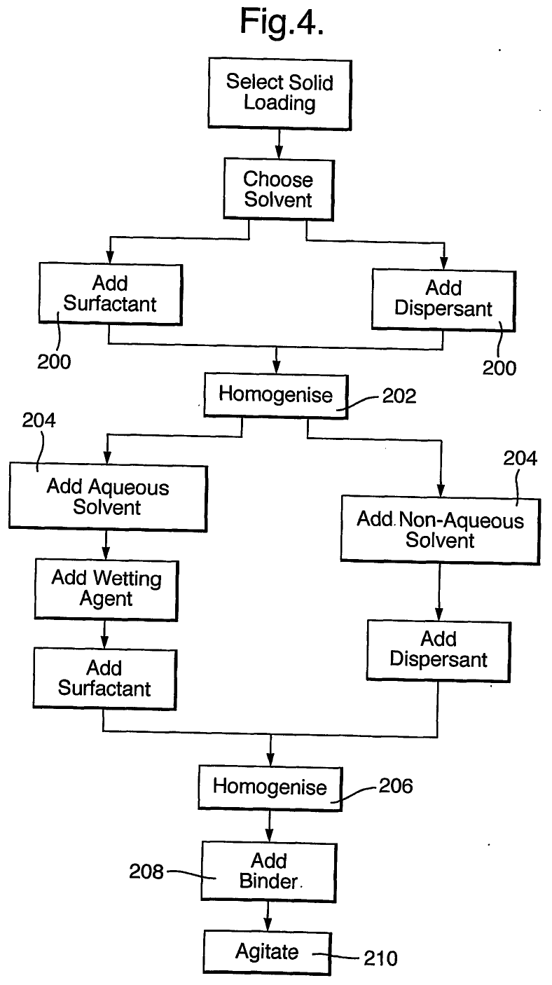

FIG. 4 is a flow chart illustrative of an alternative method of ink formulation for use in accordance with an aspect of the invention;

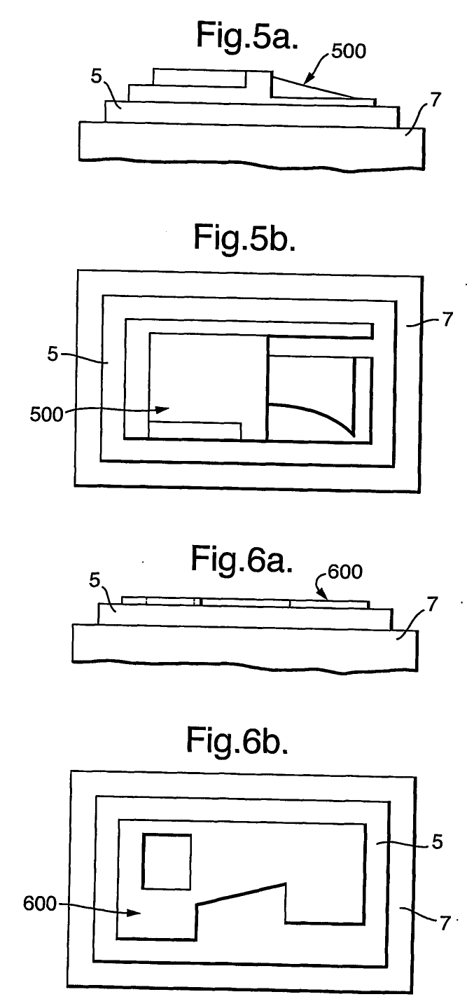

FIGS. 5a and 5b are respectively elevation and plan views of an example structure deposited in accordance with a method of the invention;

FIGS. 6a and 6b are respectively elevation and plan views of a further example structure deposited in accordance with a method of the invention;

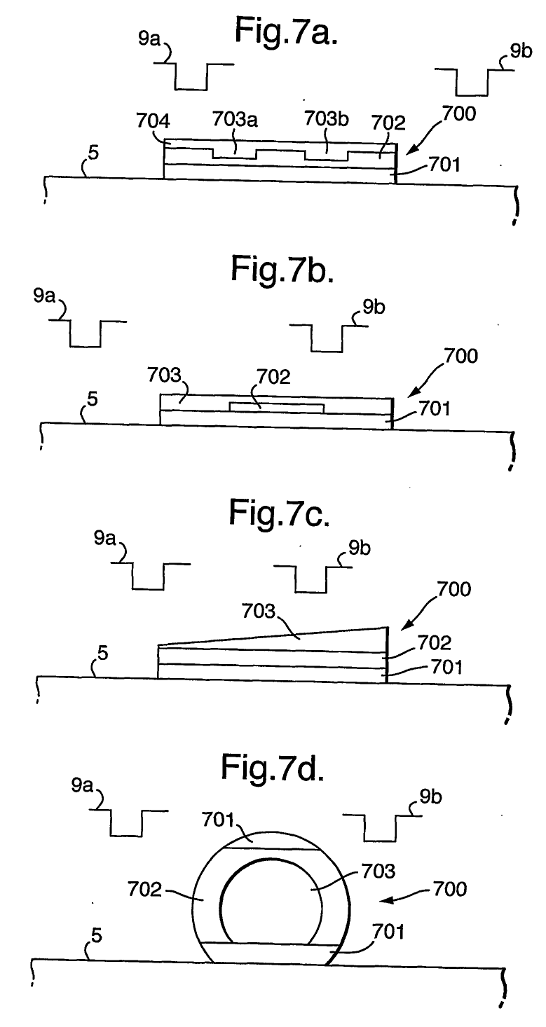

FIGS. 7a to 7d illustrate further examples of a structure in accordance with a further aspect of theinvention; and

FIG. 8 is a schematic diagram illustrating a prior art Solid Oxide Fuel Cell.

Referring to FIG. 1, there is shown an ink jet printer 1 under software control. The printer 1 is capable of delivering ink to a surface 3 of medium 5 which in this case is a polymeric release film. The printer 1 is provided with a fixed bed 7 whilst each of a pair of print heads 9a,9b is capable of movement in the z-plane in addition to movement in the x and y plane. Each of the print heads 9 is of the piezo-electric type as exemplified by a commercially available Siemens P2 print head. Clearly, it is envisaged that other ink jet deposition print heads may be utilised including not only those where the ejection of ink is brought about as a result of a piezo-electric distortion of an ink cavity but also print heads having thermal or shock wave based ejection mechanisms. The print heads 9 are fed by separate reservoirs 11a,11b to facilitate delivery of different inks without having to repeatedly flush and refill each reservoir 11 and print head 9 more than necessary. Each print head 9 operates in accordance with a drop on demand process whereby ink is ejected by the print head 9 solely when it is required for deposition on a medium surface.

Turning to FIG. 2, this illustrates in more detail the print head 9 which includes a nozzle 13 of around 18 μm in diameter through which droplets of ink are ejected so as to impinge on the surface 3 of the medium 5. Preferably, a print head 9 is selected with a nozzle diameter which provides the desired characteristics in both shape and volume of ejected ink. The composition and processing steps required to form an ink suitable for printing with the printer 1 are described in detail below.

Referring to the flowchart of FIG. 3, an ink containing nano-sized particles, i.e. individual particles having a maximum dimension less than 1 μm, is formulated by firstly selecting 100 a solid starting material such as, but not limited to, a metal powder, metal salts, metal oxides and ceramic material. Examples of metals include silver, silver/palladium and platinum whilst examples of ceramics include lead zirconate titanate, zirconia and alumina. The individual particles typically have a size in the range of 2 μm to 10nm.

To the starting material or solid loading as it may also be described, is added 102 a solvent carrier. Typically, the solvent carrier will contain between 5% and 60% by volume starting material. The solvent carrier must be selected so that it will not destructively interfere with the print head 9 as a result of a chemical process and/or tribological action. Consequently, a solvent such as toluene or acetone should be avoided as should certain types of starting material which have a tribolgical impact, unless, of course, such wear is deemed acceptable. Similarly, the starting material should be selected such that it does not exhibit electrostatic or Van der Waals forces which are sufficient to bring about agglomerations of the starting material which might interfere with the operation of the print head 9 through the formation of blockages, for example. The solvent should also be selected for its ability to wet the print head 9 and also with a view to defining the drying time of the ink once in contact with the medium 5. The choice of an aqueous or non-aqueous solvent will, again, depend on the nature of the starting material. Examples of non-aqueous dispersants include ethyl-lactate and those which are alcohol based including combinations of ethanol and propan-2-ol, ethylene glycol and other alcohols. In the case of an aqueous solution it has been found necessary to add a small amount of an alcohol such as ethanol to provide the wetting characteristics necessary to ensure the final ink composition is capable of wetting the print head 9.

In addition to the solvent, it has also been found advantageous to add 104 a dispersant or a surfactant to the mixture of the solid material and solvent. It will be appreciated that a surfactant is particularly suitable, of course, for use with an aqueous solvent. The molecular structure of the dispersant or surfactant is such that each molecule has one end compatible with the material and another end which is compatible with the solvent. As a result, the dispersant or surfactant binds the solvent to the material. The choice between a surfactant or a dispersant will depend on the nature of the interface which is to be formed between the constituents of the composition. A dispersant is, of course, capable of forming interfaces between solid and liquid phases only, whereas a surfactant can not only form interfaces between solid and liquid phases but also between solid and solid, solid and liquid, solid and gas, liquid and liquid and liquid and gas phases.

One example of a formulation which has achieved favourable results is one containing 5% by volume silver oxide, EFHK 440 as a dispersant at 2% by weight of the silver oxide mass and the remainder being an ethanol/propanol solvent carrier.

The resulting mixture is then homogenised 106 using a process such as milling. The process may be carried out for a number of hours. Typically, three hours is sufficient.

In an alternative embodiment of the present invention (see FIG. 4), the dispersant or surfactant is added 200 to the starting material and both are mixed 202, typically the dispersant or surfactant is mixed by hand with the starting material. To the homogenised mixture is then added 204 sufficient solvent such that the starting material makes up between 5 to 60% by volume of the resulting mixture. The resulting mixture may then homogenised 206, preferably through a further milling process for a matter of hours perhaps three hours.

It has also further been determined experimentally that in order to avoid cavitation or blockages within the nozzle 13, it is important to control the viscosity of the ink whilst it passes through the print head 9. Preferably, the viscosity of the ink will be in the range of 10-60cPs at ambient temperature namely at a temperature in the range of around 16° C. to 35° C. More preferably, the viscosity will be selected to be in the range of 20-50 cPs.

Typically, a manufacturer of a print head 9 will provide a range of viscosities which it is considered by the manufacturer are appropriate for an ink to be successfully deposited from the print head 9. Surprisingly, it has been found that inks in accordance with present invention may still be printed successfully despite having a viscosity laying outside the range specified by the print head manufacture. It is believed that this is because the inks types considered by the manufacturer when determining the recommended viscosity range differ significantly in their desired characteristics from those of the present invention. To take one example, whilst drying time is a significant attribute in relation to known inks suited for conventional printing operations, this is not the case with inks of the present invention where drying times may be much more extensive. In addition, the nature of the medium 5 onto which the ink may be ejected from the print head 9 is also a factor in the selection of a viscosity or viscosity range for the ink. By controlling the viscosity of the ink at the point of delivery to the medium 5 it is possible to optimise the shape and size of a drop of ink to meet the media requirements and to facilitate the build-up of a structure.

It has also been found experimentally that when multi-dimensional structures are built up using an ink, a lack of physical integrity can arise in the built up structure unless steps are taken to control the integrity during the build of the structure.

With reference again to FIGS. 3 and 4, in order to address both of the above issues, it has been found useful to add 108, 208 a further component to the homogenised mixture, namely a binder. The type and quantity of binder added to the mixture of solvent, starting material and dispersant or surfactant is again determined by the required complexity of the built up structure and the factors determining the desired viscosity set out above. The binder itself has to be soluble in the selected solvent and removable from the built up structure by a post printing process such as leaching or firing, for example. Some suitable binders have been found to be polyvinylalcohol (PVA) and polyvinylbutryol (PVB) for non-aqueous alcohol based solvents. Latex has been found to be a suitable binder for aqueous solvents.

The final step 110,210 in the preparation of the ink is to subject it to agitation in order to break down any tendency for the material to agglomerate. It has been found that ultrasonic techniques such as the use of an ultrasonic probe also known as a horn or alternatively an ultrasonic bath are effective in breaking down any agglomerates. It is believed that the tendency for the starting material to agglomerate is due to Van der Waals forces which are interactions between closed-shell molecules and have contributions from interactions between the partial electric charges of polar molecules. Typically, the period required for ultrasonic agitation to achieve the result of breaking down large scale agglomerations is up to five minutes or so, preferably around two minutes.

It has been found useful to carry out such agitation 110,210 immediately prior to viscosity testing of the ink and also before utilising the ink in the deposition process set out in more detail below.

Once the ink has been agitated and any large agglomerations broken down, it has been found beneficial to use 112,212 the ink as soon as possible so as to minimise the opportunity for the material to agglomerate and a sediment to form. Nevertheless, it has been determined that ink prepared in the above manner can be used at a later date provided agitation 110,210 is carried out to remove any sediment which has formed. It is expected that an ink formulated in the above-described manner will become fully sedimented in no less than about six months. Accordingly, an ultrasonic probe 15 maybe incorporated in the reservoir 11 within the printer 1 itself, the agitated ink being subsequently delivered to the print head 9.

In use, the reservoir 11 of the printer 1 is filled with ink prepared in accordance with the above procedure. The printer 1 itself, as has been mentioned, is capable of delivering ink to a medium 5 placed on the bed 7 at a particular position defined by the x and y co-ordinates. Furthermore, because the bed 7 itself may be moved in the z direction it is possible to deposit ink onto the medium 5 at a number of x and y co-ordinates and at a fixed z position before displacing the bed 7 in the z direction and again depositing material at selected x and y co-ordinates. In this manner, it is possible to build up a structure 500 on the medium 5 having a three-dimensional structure (FIGS. 5a and 5b). Clearly, a two dimensional structure 600 (FIGS. 6a and 6b) can be created by depositing the ink over the medium 5 with the bed 7 held in a fixed position relative to the print head 9.

It will be recognised that control of each print head 9 and bed 7 may be placed under software control. Consequently, Computer Aided Design (CAD) software may be utilised to generate the design of a structure which can then be utilised in Computer Assisted Manufacture (CAM) of the structure by the printer. For example, the design of the structure may be created via a pixellated bit map. The software interprets the bitmap such that one pixel of the bitmap represents one ink drop. A three dimensional structure may be built up by referring to a superimposed set of such bitmaps. This allows unique structures to be designed and produced on a drop by drop basis enabling complex geometries and hybrid structures to be realised.

FIGS. 7a to 7d illustrate in cross-section how a number of different structures 700 may be built up from a series of layers deposited onto the polymeric release film 5. The particular solid loads used in the inks deposited in the structures 700 described below will depend, of course, on the function of the structure 700. For example, a Solid Oxide Fuel Cell will include an anode, an electrolyte and a cathode as well as any interconnects required to facilitate formation of a stack.

In the Figures that follow, the particular geometries are intended to be examples of the sort of complex structures that can be achieved such as might be applied to a Solid Oxide Fuel Cell or a micro electro mechanical system (MEMS), to take just two such types of device.

In FIG. 7a, a first layer 701 is deposited directly onto the release film 5. The first layer 701 is of constant thickness and is delivered from a first reservoir of ink 11 containing a predetermined nanometric solid loading using a print head 9 connected to the reservoir. The second layer 702 deposited on the first layer 701 is built-up by initially delivering material from a second reservoir 11 using a corresponding printhead 9. However once a certain thickness of this layer 702 has been achieved, another print head connected to a further reservoir 11 containing an ink having a different nanometric solid loading is used to deposit ink in the two regions 703a,703b. Ultimately, deposition of material from the second reservoir stops and ink from the further reservoir is delivered in an uninterrupted layer 704 over the entire cross-section of the device.

Similarly in FIG. 7b, the inclusion 702 is formed by using both first and second print heads 9a,9b connected to respective reservoirs 11 to deposit the selected inks over the relevant portions of the cross-section of the structure. The inclusion itself may be formed of fugitive material such that a void may remain within the cross-section of the structure following a post deposition sintering or similar operation.

In FIG. 7c, there is shown a graded structure 700 in which an ink is deposited 703 in a graded amount over the cross section of the structure built up from an initial set of two layers 701,702 each of constant thickness.

In FIG. 7d, it is shown how with control of the print heads 9 and there appropriately provisioned reservoirs 11 containing suitably loaded inks 701,702 and fugitive material can produce a tubular cross section having a central portion of fugitive material 703 which can be removed in a post deposition step to form a void.

It will be appreciated that above examples are not intended to be limiting in respect of the type of structure 700 which can be achieved.

Such flexibility in generation of structures is particularly applicable to the creation of Solid Oxide Fuel Cells, where metallic or other forms of interconnect between cells may be deposited together with the other elements of the stack. As a result, a complete stack can be built-up and subsequently sintered in a single operation rather than the series of laying up and sintering operations required in the prior art.

1. A solid structure fabrication method, the method comprising filling each of a plurality of reservoirs with a selected ink, each said ink containing a solid material loading of nanosized particles, ejecting a selected ink from a print head connected to a corresponding reservoir towards a medium surface, the print head and medium surface being movable relative to each other in a plane defined by first and second directions and in a third direction orthogonal to said plane.

2. A method as claimed in claim 1, wherein the solid structure is generated as a plurality of layers, each layer being laid down by ejecting at least one selected ink towards the medium surface.

3. A method as claimed in claim 2, wherein a contiguous feature of said solid structure is generated by selectively ejecting a selected ink towards the medium surface so as to form a set of at least partially superimposed portions of said layers.

4. A method as claimed in claim 1, comprising filling a reservoir with a fugitive material and ejecting the fugitive material from a print head connected to the reservoir towards the medium surface.

5. A method as claimed in any claim 1, wherein the structure is separated from said medium surface.

6. A method as claimed in claim 1, comprising selecting the solid material loadings to form a structure having an anode, a cathode and an electrolyte.

7. A solid oxide fuel cell fabrication method, the method comprising filling each of a plurality of reservoirs with a selected ink corresponding to an anode, electrolyte and cathode material, each ink containing a solid material loading of nanosized particles, wherein the solid oxide fuel cell is generated as a plurality of layers, each layer being laid down by ejecting at least one selected ink towards a medium surface such that an electrolyte layer separates a cathode and anode layer to form a cell.

8. A method as claimed in claim 7, wherein the layers are removable from the medium surface.

9. A method as claimed in claim 7, wherein at least one reservoir is filled with a fugitive material and selectively ejected towards the medium surface.

10. A method as claimed in claim 9, wherein a post deposition sintering operation is carried out.

11. A method as claimed in claim 7, wherein at least one reservoir is filled with a selected ink corresponding to an interconnect material, the ink containing a solid material loading of nanosized particles, wherein a contiguous interconnect feature is generated by selectively ejecting said selected ink towards the medium surface so as to form a set of at least partially superimposed portions of said layers.

12. A method as claimed in claim 11, where a stack of solid oxide fuel cells is formed by depositing a plurality of sets of anode and cathode layers each separated by an electrolyte layer such that said cells are interconnected by respective interconnect features.

13. An ink-jet deposition apparatus for use in accordance with the method of claim 7 to deposit a structure on a medium surface, the apparatus comprising a plurality of print heads connectable to a selected ink reservoir, the print heads and medium surface being movable relative to each other in a plane defined by first and second directions and in a third direction orthogonal to said plane.

14. A structure deposited in accordance with the method of claim 7, wherein the structure is removable from the medium surface.

15. A structure as claimed in claim 14, wherein the medium surface is a polymeric release film.
